(19) United States
(12) Patent Application Publication
(10) Pub. No.: US 2021/0208444 A1
(43) Pub. Date: Jul. 8, 2021

(54) ELECTROOPTIC APPARATUS

(71) Applicant: Japan Display Inc., Tokyo (JP)

(72) Inventors: Shinichiro OKA, Tokyo (JP); Yosuke HYODO, Tokyo (JP); Toshiyuki HIGANO, Tokyo (JP); Emi HIGANO, Tokyo (JP)

(73) Assignee: Japan Display Inc., Tokyo (JP)

(21) Appl. No.: 17/208,500

(22) Filed: Mar. 22, 2021

Related U.S. Application Data
(63) Continuation of application No. PCT/JP2019/031422, filed on Aug. 8, 2019.

(30) Foreign Application Priority Data
Sep. 26, 2018 (JP) 2018-180368

(51) Int. Cl. G02F 1/1345; G02F 1/1333; G02F 1/1339

(52) U.S. Cl. CPC G02F 1/13452; G02F 1/1339; G02F 1/133345

(57) ABSTRACT

An electrooptic apparatus includes: a flexible first substrate having a first front surface; a liquid crystal layer (electrooptic layer) formed above the first front surface of the first substrate; a transistor element between the first substrate and the liquid crystal layer; a first wiring being closer to the first front surface and electrically connected to the transistor element; a first organic film between the first substrate and the first wiring; and a first inorganic insulating film between the transistor element and the first substrate and on the first front surface of the first substrate. The first substrate further includes: a first portion overlapping a display region and the insulating film; and a second portion not overlapping the insulating film 11 and including a bending region. The first wiring overlaps the first and second portions, and a thickness of the second portion is smaller than a thickness of the first portion.

### CROSS-REFERENCE TO RELATED APPLICATION

The present application claims priority from Japanese Patent Application No. 2018-180368 filed on Sep. 26, 2018, the content of which is hereby incorporated by reference into this application.

### TECHNICAL FIELD

The present invention relates to an electrooptic apparatus using a liquid crystal layer, and relates to a technique effectively applied to a display apparatus using a bent peripheral region of a flexible substrate.

### BACKGROUND ART

There is a technique of using a substrate having flexibility as a substrate configuring a display apparatus (see Japanese Patent Application Laid-Open Publication No. 2015-118373 (Patent Document 1)).

### RELATED ART DOCUMENT

### Patent Document

Patent Document 1: Japanese Patent Application Laid-Open Publication No. 2015-118373

### SUMMARY OF THE INVENTION

### Problems to be Solved by the Invention

When a substrate having flexibility is used, an area of a peripheral region out of a display region can be reduced since the substrate can be bent. However, apart of a wiring that electrically connects an electrode in the display region and a driving circuit in the peripheral region is arranged in the bending region. Therefore, in order to improve reliability of the display apparatus using the substrate having flexibility, it is necessary to improve reliability of the wiring extending so as to straddle the bending region. For example, it is necessary to prevent the wiring extending so as to straddle the bending region from being damaged by influence of stress that is applied to a periphery of the bending region.

An objective of the present invention is to provide a technique capable of improving a performance of an electrooptic apparatus.

### Means for Solving the Problems

An electrooptic apparatus according to one aspect of the present invention includes: a flexible first substrate having a first front surface; an electrooptic layer formed above the first front surface of the first substrate; a transistor element between the first substrate and the electrooptic layer; a first wiring being closer to the first front surface and electrically connected to the transistor element; a first organic film formed between the electrooptic layer and the first wiring; and a first inorganic insulating film formed between the first wiring and the first substrate and formed on the first front surface of the first substrate. The first substrate further has a first portion that overlaps a display region and the first inorganic insulating film and a second portion that is adjacent to the display region, that does not overlap the first inorganic insulating film and that includes a bending region. A thickness of the second portion of the first substrate is smaller than a thickness of the first portion.

### BRIEF DESCRIPTIONS OF THE DRAWINGS

FIG. 1 is a planar view showing one example of a display apparatus according to one embodiment;

FIG. 2 is a cross-sectional view taken along a line A-A of FIG. 1;

FIG. 3 is an enlarged cross-sectional view of a part of a display region in FIG. 1;

FIG. 4 is a circuit diagram showing a circuit configuration example in periphery of one pixel of the display apparatus in FIG. 1;

FIG. 5 is an enlarged planar view enlarging and showing periphery of a bending region of the display apparatus in FIG. 1;

FIG. 6 is an enlarged cross-sectional view taken along a line A-A of FIG. 5;

FIG. 7 is an enlarged cross-sectional view taken along a line B-B of FIG. 5;

FIG. 8 is an enlarged cross-sectional view sequentially showing steps of forming a step portion shown in FIG. 6;

FIG. 9 is an enlarged cross-sectional view of a display apparatus according to a modification example of the display apparatus shown in FIG. 6;

FIG. 10 is an enlarged cross-sectional view of a display apparatus according to a modification example of the display apparatus shown in FIG. 9;

FIG. 11 is an enlarged cross-sectional view of a display apparatus according to another modification example of the display apparatus shown in FIG. 9;

FIG. 12 is a planar view showing a modification example of FIG. 1; and

FIG. 13 is a cross-sectional view taken along a line A-A of FIG. 12.

### BEST MODE FOR CARRYING OUT THE INVENTION

Hereinafter, each embodiment of the present invention will be described with reference to the accompanying drawings. Note that only one example is disclosed, and appropriate modification keeping the concept of the present invention which can be easily anticipated by those who are skilled in the art is obviously within the scope of the present invention. Also, in order to make the clear description, a width, a thickness, a shape, and others of each portion in the drawings are schematically illustrated more than those in an actual aspect in some cases. However, the illustration is only an example, and does not limit the interpretation of the present invention. In the present specification and each drawing, similar elements to those described earlier for the already-described drawings are denoted with the same or similar reference characters, and detailed description for them is appropriately omitted in some cases.

In the following embodiments, a liquid crystal display apparatus displaying various images in a display region will be exemplified as an electrooptic apparatus including a liquid crystal layer that is an electrooptic layer for explanation. Note that the electrooptic apparatuses include a shutter liquid crystal element and others for use in controlling light transmittance, that is used for a room mirror of a car.

The liquid crystal display apparatuses are roughly classified into the following two types depending on an application direction of an electric field for use in changing alignments of liquid crystal molecules of a liquid crystal layer. That is, a first classification is so-called vertical electric field mode that applies the electric field in a thickness direction (or an out-of-plane direction of a display surface) of the display apparatus. The vertical electric field modes include, for example, a TN (Twisted Nematic) mode, a VA (Vertical Alignment) mode and others. A second classification is so-called horizontal electric field mode that applies the electric field in a planar direction (or an in-plane direction of the display surface) of the display apparatus. The horizontal electric field modes include, for example, an IPS (In-Plane Switching) mode, a FFS (Fringe Field Switching) mode that is one of the IPS modes and others. The following explained techniques are applicable to both the vertical electric field mode and the horizontal electric field mode. However, in the following explained embodiments, the display apparatus of the horizontal electric field mode will be exemplified for explanation.

<Configuration of Display Apparatus>

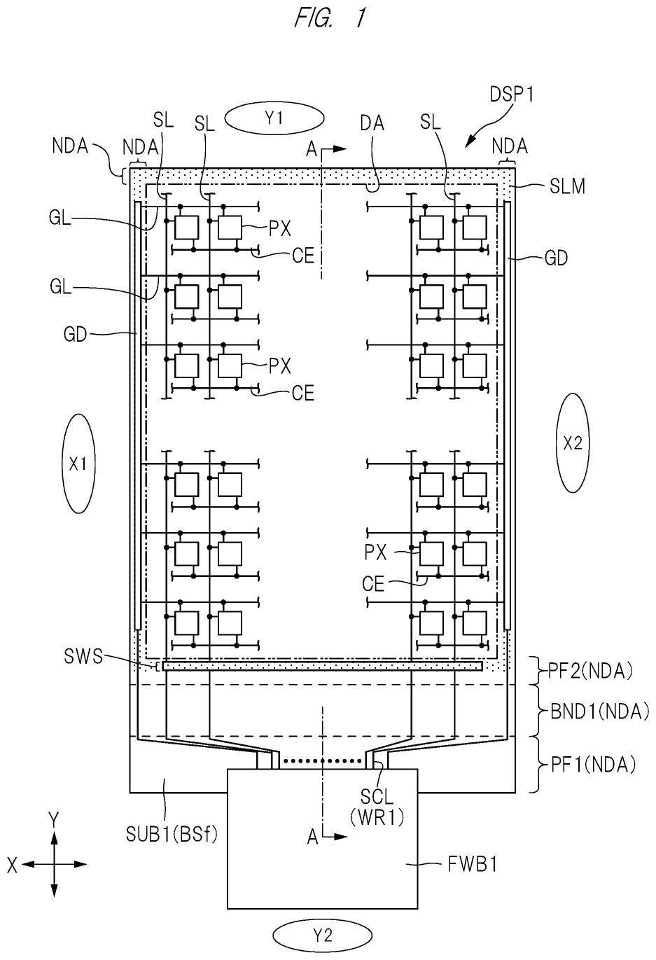

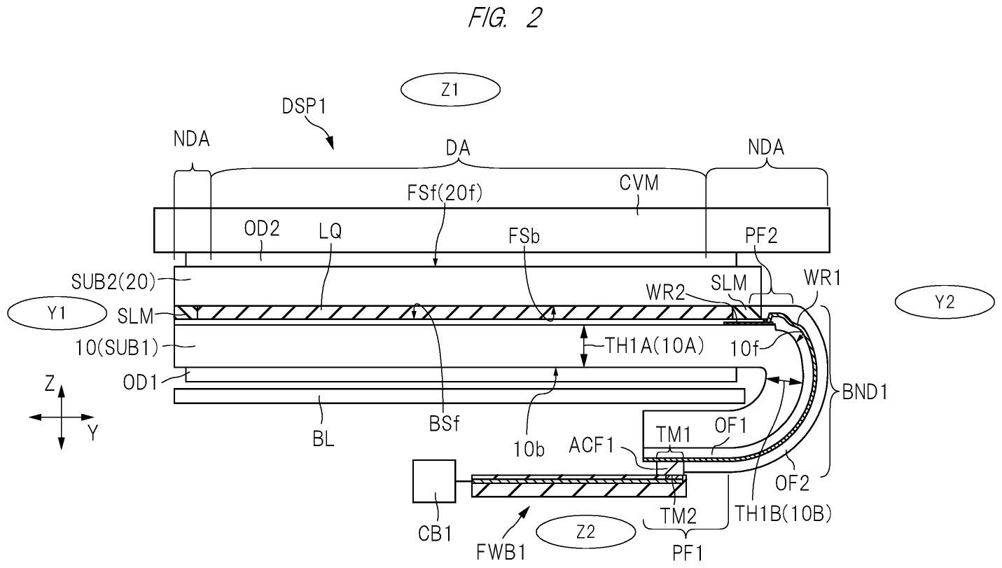

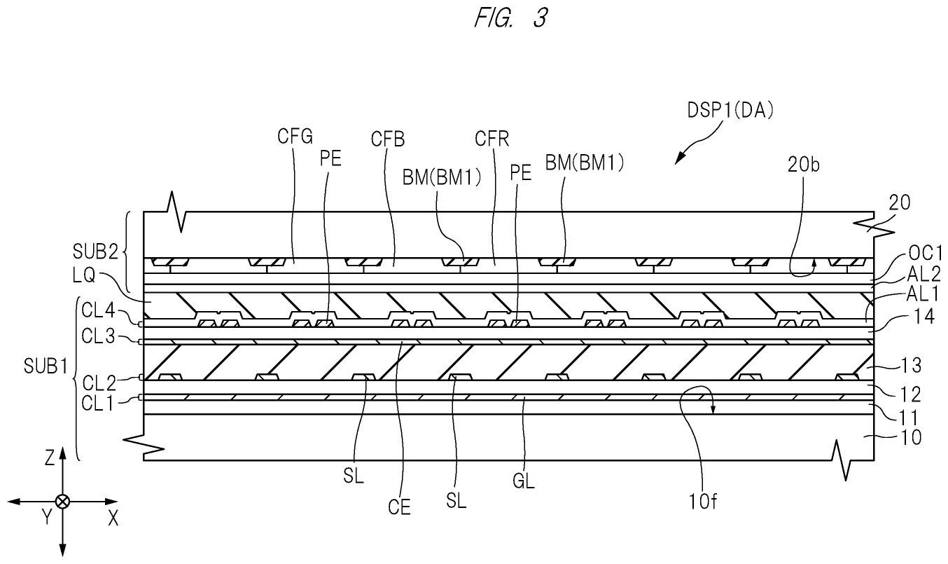

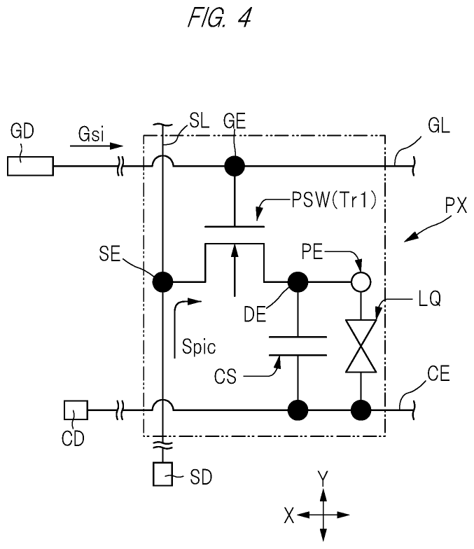

First, a configuration of the display apparatus will be explained. FIG. 1 is a planar view showing one example of the display apparatus of the present embodiment. In FIG. 1, a boundary between a display region DA and a non-display region NDA in a planar view is illustrated with a dashed double-dotted line. In FIG. 1, apart of circuit blocks and wirings corresponding to a display unit displaying images in a circuit of a display apparatus DSP1 is also schematically illustrated with a solid line. In FIG. 1, illustration of a cover member CVM (see FIG. 2) and a substrate SUB2 (see FIG. 2) facing a substrate SUB1 is omitted. In FIG. 1, a region (sealing region) where a sealing member (adhering member) SLM is arranged in a planar view is illustrated with a dot pattern. In FIG. 1, each of a boundary between a peripheral region PF1 and a bending region BND1 and a boundary between a peripheral region PF2 and the bending region BND1 is illustrated with a dotted line. Since the substrate SUB1 in FIG. 1 is bent at the bending region BND1, the peripheral region PF1 cannot be visually recognized in a planar view in a direction of a normal line with respect to the display region DA. However, FIG. 1 shows the peripheral region PF1 in order to clearly show an extending direction of a wiring WR1. FIG. 2 is a cross-sectional view taken along a line A-A of FIG. 1. Although FIG. 2 is the cross-sectional view, hatching is omitted for easiness of view except in a liquid crystal layer LQ, the sealing member SLM, the wiring WR1 of the non-display region NDA and a wiring board FWB1. FIG. 3 is an enlarged cross-sectional view of a part of the display region in FIG. 1. In order to show an example of positional relation between a gate line GL and a source line SL in a thickness direction of the substrate SUB1 (a “Z” direction shown in FIG. 1), FIG. 3 also shows a gate line GL that is arranged on a different cross section from that of FIG. 3. FIG. 4 is a circuit diagram showing an example of a circuit configuration in periphery of one pixel included in the display apparatus shown in FIG. 1.

As shown in FIG. 1, the display apparatus DSP1 of the present embodiment includes the display region DA where an image is formed in accordance with an input signal that is supplied from outside. The display apparatus DSP1 also includes the non-display region (frame region) NDA in periphery of the display region DA in a planar view. While the display region DA of the display apparatus DSP1 shown in FIG. 1 is rectangular, the display region may be not rectangular but polygonal, circular or others. The display region DA is an effective region where the display apparatus DSP1 displays the image in a planar view in which the display surface is viewed. Each of the substrate SUB1 and the substrate SUB2 (see FIG. 2) is positioned so as to overlap the display region DA in a planar view. In other words, the display region DA includes the substrate SUB1 and the substrate SUB2.

As shown in FIG. 2, the display apparatus DSP1 includes the substrate SUB1 and the substrate SUB2 that are adhered and face each other across the liquid crystal layer LQ. The substrate SUB1 and the substrate SUB2 are lined in the Z direction that is the thickness direction of the display apparatus DSP1. In other words, the substrate SUB1 and the substrate SUB2 face each other in the thickness direction (Z direction) of the display apparatus DSP1. The substrate SUB1 has a front surface (main surface, plane) Bsf that faces the liquid crystal layer LQ (and the substrate SUB2). And, the substrate SUB2 has a back surface (main surface, plane) Fsb that faces the front surface Bsf of the substrate SUB1 (and the liquid crystal layer LQ). The substrate SUB1 is an array substrate in which a plurality of transistors (transistor elements) Tr1 (see FIG. 4) functioning as switching elements (active elements) are arranged in an array form. The substrate SUB2 is a substrate closer to the display surface. The substrate SUB2 can be also referred to as a facing (opposed) substrate meaning a substrate that is arranged to face the array substrate.

The liquid crystal layer LQ is between the front surface BSf of the substrate SUB1 and the back surface FSb of the substrate SUB2. The liquid crystal layer LQ is the electrooptic layer having a function of modulating light that travels through itself by using the switching element to control a state of an electric field that is formed around the liquid crystal layer LQ. The display region DA included in the substrate SUB1 and the substrate SUB2 overlaps the liquid crystal layer LQ as shown in FIG. 2.

The substrate SUB1 and the substrate SUB2 are adhered to each other through the sealing member (adhering member) SLM. As shown in FIG. 1, the sealing member SLM is arranged in the non-display region NDA so as to surround the display region DA. As shown in FIG. 2, the liquid crystal layer LQ is inside the sealing member SLM. The sealing member SLM plays a role of a sticker for sealing the liquid crystal between the substrate SUB1 and the substrate SUB2. Besides, the sealing member SLM plays a role of an adhering member for adhering the substrate SUB1 and the substrate SUB2.

As shown in FIG. 2, the display apparatus DSP1 includes an optical device OD1 and an optical device OD2. The optical device OD1 is arranged between the substrate SUB1 and a backlight unit BL. The optical device OD2 is closer to the display surface of the substrate SUB2, in other words, is opposite to the substrate SUB1 across the substrate SUB2. Each of the optical device OD1 and the optical device OD2 includes at least a polarizer, and may include a waveplate if needed.

As shown in FIG. 2, the display apparatus DSP1 includes the cover member CVM that covers the region closer to the display surface of the substrate SUB2. The cover member CVM faces the front surface (plane) FSf opposite to the back surface (plane) Fsb of the substrate SUB2. In other words, the cover member CVM faces a front surface (plane) 20f opposite to a back surface (plane) 20b (see FIG. 3) of a substrate 20 (see FIG. 3). The substrate SUB2 (in other words, the substrate 20 in FIG. 3) is between the cover member CVM and the substrate SUB1 (in other words, the substrate 10 in FIG. 3) in the Z direction. In other words, the cover member CVM is closer to a region Z1 of the substrate SUB2 (in other words, the substrate 20 in FIG. 3) in the Z direction. The cover member CVM is a protective member that protects the substrates SUB1 and SUB2 and the optical device OD2, and is closer to the display surface of the display apparatus DSP1. However, as a modification example of the present embodiment, a case without the cover member CVM is exemplified in some cases.

The substrate SUB1 includes the substrate (base substrate, insulating substrate) 10. And, the substrate SUB2 includes the substrate (base substrate, insulating substrate) 20. Each of the substrates 10 and 20 has a property that transmits visible light. The substrate 10 has flexibility. As exemplified in FIG. 2, a peripheral region PF1 of the substrate SUB1 and a peripheral region PF2 of the substrate SUB2 overlap each other in a planar view. A part of the non-display region NDA of the substrate SUB1 is bent. In other words, the peripheral region PF1 in the non-display region NDA of the substrate SUB1 but out of the sealing member SLM has a curved portion. In still other words, the front surface BSf of the substrate SUB1 (more specifically, the front surface 10f of the substrate 10 in FIG. 3) includes a flat surface region and a curved surface region curving toward the thickness direction (Z direction). The substrate SUB1 is as flexible as being curved/deformed as shown in FIG. 2. In order to make the substrate SUB1 flexible as described above, the substrate 10 has flexibility. As a constituent material of the substrate 10 having the flexibility, a resin material containing a polymer such as polyimide, polyamide, polycarbonate, polyester or others can be exemplified for the substrate 10. On the other hand, in the example shown in FIG. 2, the back surface FSb of the substrate SUB2 is a flat surface, and does not have a curved surface region. Therefore, the substrate 20 may not have the flexibility. In this case, a material configuring the substrate 20 has a larger degree of freedom of options than that of the material configuring the substrate 10. However, in a case of curving/deformation of the peripheral region PF2 of the substrate SUB2 as described later in modification examples, it is necessary to make the substrate 20 flexible. In this case, the substrate 10 and the substrate 20 are made of the same material as each other. Of course, even when the substrate SUB2 is not bent, the substrate 10 and the substrate 20 may be made of the same material as each other.

As shown in FIG. 3, the substrate 10 has the front surface (main surface, plane) 10f that faces the liquid crystal layer LQ (and the substrate 20). And, the substrate 20 has the back surface (main surface, plane) 20b that faces the front surface 10f of the substrate 10 (and the liquid crystal layer LQ). The liquid crystal layer LQ is between the front surface 10f of the substrate 10 and the back surface 20b of the substrate 20.

As shown in FIG. 3, the substrate SUB1 has a plurality of conductive patterns between the substrate 10 and the liquid crystal layer LQ. The plurality of conductive patterns between the substrate 10 and the liquid crystal layer LQ include a plurality of gate lines (scan lines) GL, a plurality of source lines (signal lines) SL, a common electrode CE and a plurality of pixel electrodes PE. An insulating film intervenes between the plurality of conductive patterns. The insulating films arranged between the adjacent conductive patterns and electrically isolating the conductive patterns include insulating layers 11 to 14 and an alignment film AL1. Note that FIG. 3 shows one gate line GL and one common electrode CE.

Each of the plurality of conductive patterns configures apart of a plurality of wiring layers layered on the substrate 10. In the display region DA of the display apparatus DSP1 in the example shown in FIG. 3, conductive layers CL1 CL2, CL3 and CL4 are formed in this order from the front surface 10f of the substrate 10. In an overlap portion of the conductive layer CL1 with the display region DA, the gate line GL of the transistor Tr1 (see FIG. 4) is mainly formed. In an overlap portion of the conductive layer CL2 with the display region DA, the source line SL is mainly formed. In an overlap portion of the conductive layer CL3 with the display region DA, the common electrode CE is mainly formed. In an overlap portion of the conductive layer CL4 with the display region DA, the pixel electrode PE is formed.

Each of the conductive layers CL1 and CL2 contains a metallic material. The conductive pattern of the conductive layer CL1 includes a metallic film made of, for example, a metal such as molybdenum (Mo) or tungsten (W) or an alloy of such a metal. The conductor pattern of the conductive layer CL2 includes a metallic film having, for example, a multilayer structure such as a layered film made of an aluminum (Al) film sandwiched by titanium (Ti) films, titanium nitride (TiN) films or others. Each of the conductive layer CL3 and the conductive layer CL4 mainly contains a conductive oxide material (transparent conductive material) such as ITO (Indium Tin Oxide), IZO (Indium Zinc Oxide) or others.

An insulating film is formed in respective gaps among the substrate 10 and the conductive layers CL1 to CL4. Each of the insulating films 11, 12 and 14 is an inorganic insulating film made of an inorganic material. Each of the insulating films 11 and 12 is made of, for example, a silicon nitride (SiN) film, a silicon oxide (SiO) film, an aluminum oxide (AlOx) film or a layered film made of such films.

Between the insulating film 11 and the insulating film 12, not only the gate line GL but also a semiconductor layer, a gate electrode GE of the transistor (transistor element) Tr1 functioning as a pixel switch element PSW shown in FIG. 4 and others are formed. The transistor Tr1 shown in FIG. 4 is a thin film transistor (TFT). The gate line GL includes the gate electrode GE of the transistor Tr1 functioning as the pixel switch element PSW.

In the present embodiment, the substrate 10 is made of an organic material such as polyimide. Since the substrate 10 has the flexibility, the front surface 10f of the substrate 10 is flexible. Therefore, when the conductive layer CL1 is directly formed on the front surface 10f of the substrate 10, there is a concern that the conductive pattern of the conductive layer CL1 peels off from the substrate 10 in a step of forming and patterning the film of the conductive material configuring the conductive layer CL1. When the insulating film 11 that is the inorganic insulating film is arranged between the substrate 10 and the conductive layer CL1 as described in the present embodiment, it is more difficult to cause the peeling of the conductive pattern than the case without the insulating film 11.

When the inorganic insulating film is used as the insulating films 11 and 12, it is easy to control the property of the transistor Tr1. As described above, the inorganic insulating film has an effect that makes the conductive pattern easy to be formed or an effect that makes the electric property of the transistor Tr1 easy to be controlled. However, in a point of view of flattening of a film surface, the organic insulating film is more preferable than the inorganic insulating film because of being able to be thickly layered. Therefore, in order to maintain the flatness of the common electrode CE, the organic insulating film that is easier to be flattened than the insulating films 11 and 12 that are the inorganic insulating films is used for the insulating film 13. As one example of the insulating film 13, an organic insulating film made of, for example, an acrylic photosensitive resin can be exemplified.

In the example shown in FIG. 3, the common electrode CE is arranged between the insulating film 13 and the insulating film 14. However, modification examples include a case of arrangement of a wiring (common signal line) for use in supplying a potential for the common electrode CE, between the insulating film 13 and the common electrode CE or between the insulating film 14 and the common electrode CE.

As shown in FIG. 1, each of the plurality of gate lines GL extends in an X direction. The plurality of gate lines GL are arranged so as to be apart from one another in the Y direction. In other words, the plurality of gate lines GL are arranged from a Y1 side that is one side of the Y direction toward a Y2 side that is the other side. Each of the plurality of gate lines GL is drawn out toward the non-display region NDA out of the display region DA, and is connected to a gate driving circuit (scan-line driving circuit) GD. The gate driving circuit GD is a scan-signal output circuit that outputs a scan signal Gsi (see FIG. 4) input to the plurality of gate line GL. The gate driving circuit GD is in the non-display region NDA of the substrate SUB1.

Apart (wiring part) of an image signal line inside the display region DA is called the source line SL, the image signal line being a signal transmission path being connected to a signal-line driving circuit SD (see FIG. 4) and supplying the image signal to the plurality of pixels PX. A part (wiring part) of the image signal line out of the display region DA is called a signal connection wiring SCL. Each of the plurality of source lines SL extends in the Y direction. On the other hand, the signal connection wiring SCL has a part extending in a direction crossing the Y direction. As shown in FIG. 1, each of the plurality of source lines SL (signal lines, image signal lines) extends in the Y direction. The plurality of source lines SL are arranged so as to be apart from one another in the X direction. In other words, the plurality of source lines SL are arranged from an X1 side that is one side of the X direction toward an X2 side that is the other side. Each of the plurality of source lines SL is drawn out toward the non-display region NDA out of the display region DA.

Each of the plurality of source lines SL is connected to a pixel electrode PE through the transistor Tr1 as shown in FIG. 4. More specifically, the source line SL is connected to a source electrode SE of the transistor Tr1, and the pixel electrode PE is connected to a drain electrode DE of the transistor Tr1. When the transistor Tr1 is being turned ON, the image signal Spic is supplied from the source line SL to the pixel electrode PE. The image signal Spic is supplied from the signal-line driving circuit SD. As shown in FIG. 1, the source line SL inside the display region DA is electrically connected to the signal-line driving circuit SD through the signal connection wiring SCL functioning as a connection wiring (also referred to as drawing-out wiring). The signal-line driving circuit SD supplies the image signal Spic (see FIG. 4) to the pixel electrode PE (see FIG. 4) included in each of the plurality of pixels PX through the source line SL. The signal-line driving circuit SD is formed in, for example, a wiring board (flexible wiring board) FWB1 shown in FIGS. 1 and 2 or in a circuit board CB1 shown in FIG. 2.

In the example shown in FIG. 1, a switch circuit unit SWS is arranged between the source line SL and the signal connection wiring SCL. The switch circuit unit SWS is, for example, a multiplexer circuit, and supplies (outputs) a signal to a source line SL that is selected from the plurality of source lines SL. For example, in a case of three-type source lines SL for a red color, a blue color and a green color, the switch circuit unit SWS supplies (outputs) the signal to a source line SL for a selected color. When the plurality of source lines SL are connected to the switch circuit SWS, the number of wirings connecting the switch circuit SWS and the signal-line driving circuit SD can be made smaller than the number of the source lines SL.

In the display region DA of the substrate SUB1, the common electrode CE and the pixel electrode PE (see FIG. 3) are formed. In a display period in which the display apparatus DSP1 displays the image, the electric field for driving the liquid crystal molecules is formed in accordance with a potential difference between the common electrode CE and the pixel electrode PE. As shown in FIG. 3, the common electrode CE is formed on the insulating film 13. To the common electrode CE, a driving potential that is common among the plurality of pixels PX (see FIG. 1) is supplied in the display period. The common driving potential is supplied from a common-electrode driving circuit CD (see FIG. 4) shown in FIG. 4. The common-electrode driving circuit CD is formed in the wiring board FWB1 shown in FIG. 2 or in a circuit board CB1. The common electrode CE is arranged in the entire display region DA. One common electrode CE may be arranged in the display region DA, or a plurality of common electrodes CE may be arranged in the display region DA. For the common electrode CE, a transparent conductive material made of a conductive oxide such as ITO (Indium Tin Oxide) or IZO (Indium Zinc Oxide) is preferably used.

In the example shown in FIG. 3, the plurality of pixel electrodes PE are formed on the insulating film 14. Each pixel electrode PE is positioned between two source lines SL that are adjacent to each other in a planar view. In the example shown in FIG. 3, the common electrode CE and the pixel electrode PE are formed in different layers from each other. However, as a modification example, a plurality of common electrodes CE and a plurality of pixel electrodes PE may be formed on the same plane (such as the insulating film 13) and alternately arranged so as to be adjacent to each other. Alternatively, the common electrode CE may be formed in the substrate SUB2. For the pixel electrode PE, a metallic material or a transparent conductive material such as ITO or IZO is preferably used. Each of the plurality of pixel electrodes PE is electrically connected to the source line SL and the signal connection wiring SCL through the transistor Tr1 shown in FIG. 4 as described above.

Each of the plurality of pixel electrodes PE is covered with the alignment film AL1. The alignment film AL1 is an organic insulating film having a function of unifying initial alignments of the liquid crystal molecules contained in the liquid crystal layer LQ, and is made of, for example, a polyimide resin. The alignment film AL1 is in contact with the liquid crystal layer LQ.

As shown in FIG. 3, between the liquid crystal layer LQ and the back surface (main surface, plane) 20b of the substrate 20 facing the substrate SUB1, the substrate SUB2 includes a light-blocking film BM, color filters CFR, CFG and CFB, an insulating film OC1 and an alignment film AL2.

The color filters CFR, CFG and CFB are formed in a region closer to the back surface 20b that faces the substrate SUB1. In the example shown in FIG. 3, the color filters CFR, CFG and CFB of three colors that are red (R), green (G) and blue (B) are periodically arranged. In the color display apparatus, a color image is displayed by grouping, for example, the three-color pixels of the red (R), the green (G) and the blue (B) into one set. The plurality of color filters CFR, CFG and CFB of the substrate SUB2 are arranged at positions facing the respective pixels PX (see FIG. 1) having the respective pixel electrodes PE formed in the substrate SUB1. Note that the types of the color filters are not limited to the three colors that are the red (R), the green (G) and the blue (B).

The light-blocking film BM is arranged boundaries among the color filters CFR, CFG and CFB of the respective colors. The light-blocking film BM is called black matrix, and is made of, for example, a black resin or a low-reflective metal. The light-blocking film BM is formed to have, for example, a grid form in a planar view. In other words, the light-blocking film BM extends in the X and the Y directions. More specifically, the light-blocking film BM has a plurality of portions extending in the Y direction and a plurality of portions extending in the X direction crossing the Y direction. Each pixel PX is partitioned by the black matrix, so that light leakage and color mixture can be suppressed.

The light-blocking film BM is formed in the non-display region NDA of the substrate SUB2. The non-display region NDA overlaps the light-blocking film BM. The display region DA is defined as an inner region of the non-display region NDA. The non-display region NDA is a region overlapping the light-blocking film BM that blocks the light that is emitted from the backlight unit (light source) BL shown in FIG. 2. While the light-blocking film BM is also formed inside the display region DA, the light-blocking film BM in the display region DA is formed to have a plurality of openings. Generally, among the openings which are formed in the light-blocking film BM and from which the color filters are exposed, an end of an opening that is the closest to an edge is defined as a boundary between the display region DA and the non-display region NDA.

The insulating film OC1 shown in FIG. 3 covers the color filters CFR, CFG and CFB. The insulating film OC1 functions as a protective film that prevents impurities from spreading from the color filters to the liquid crystal layer. The insulating film OC1 is an organic insulating film made of, for example, an acrylic-based photosensitive resin or others.

<Detailed Structure of Non-Display Region>

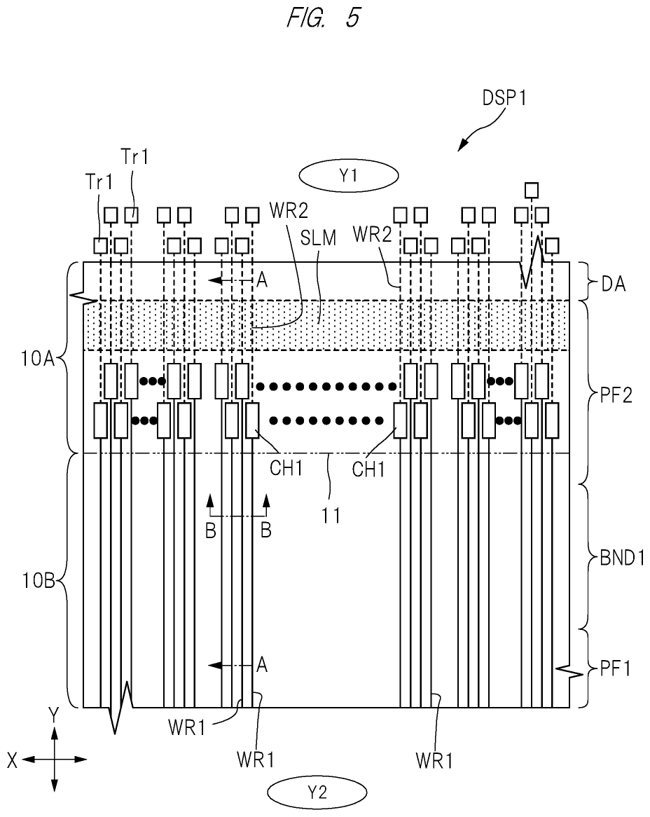

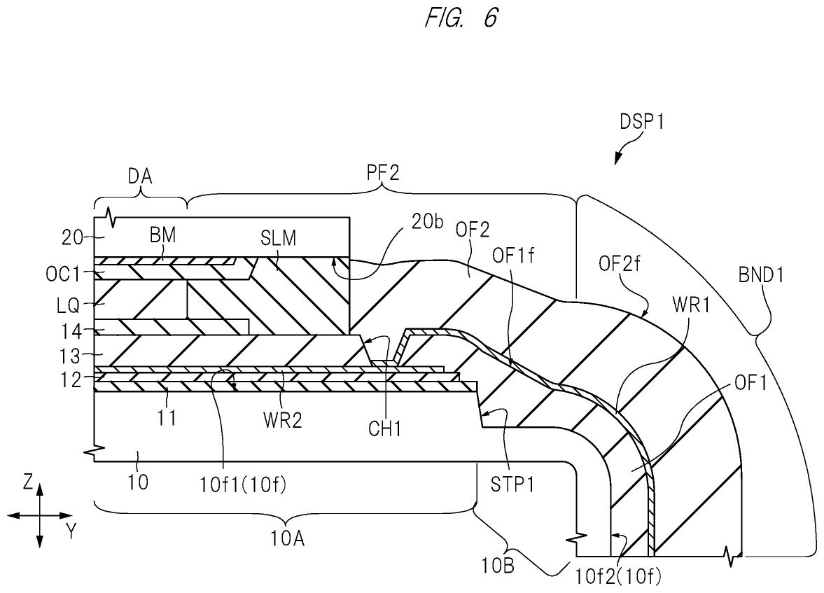

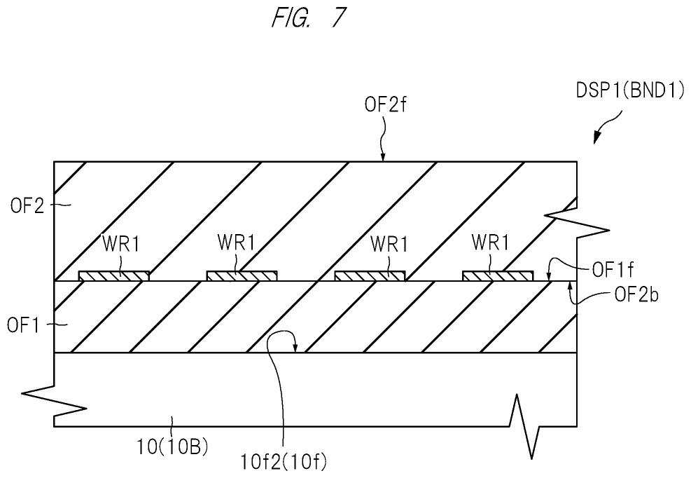

Next, a detailed structure of the non-display region NDA of the display apparatus DSP1 shown in FIG. 1 will be explained. FIG. 5 is an enlarged planar view enlarging and showing a periphery of a bending region of the display apparatus shown in FIG. 1. FIG. 6 is an enlarged cross-sectional view taken along a line A-A in FIG. 5, and FIG. 7 is an enlarged cross-sectional view taken along a line B-B in FIG. 5. As shown in FIG. 2, the peripheral region PF1 is behind the display region DA. In FIG. 5, each of the plurality of wirings WR1 and the plurality of openings CH1 is shown with a solid line, and the plurality of wirings WR2 are shown with a dotted line. In FIG. 5, the plurality of transistors Tr1 connected to the wirings WR2 are schematically shown with a rectangle. In FIG. 5, an edge of the insulating film 11 shown in FIG. 6 is shown with a dashed double-dotted line.

As shown in FIG. 1, the display apparatus DSP1 includes: the display region DA surrounded by the sealing member SLM; the peripheral region PF1 out of (in other words, in periphery of) the display region DA; the peripheral region PF2 being adjacent to the display region DA and being between the peripheral region PF1 and the display region DA; and the bending region BND1 between the peripheral region PF1 and the peripheral region PF2. The bending region BND1 is a portion at which the substrate 10 shown in FIG. 2 and each member arranged on the substrate 10 are bent, and has a certain area. In FIG. 1, both ends of the bending region BND1 are shown with a dotted line.

When the substrate SUB1 including the substrate 10 is bent as shown in FIG. 2, the width of the non-display region DNA on the Y2 side of the Y direction can be reduced. In the case shown in FIG. 2, the wiring board FWB1 is connected to the substrate 10 at a position at which the backlight unit BL overlaps itself. When a Z2 side of the Z direction shown in FIG. 2 is viewed from a Z1 side that is closer to the display surface, if the area of the visually-recognizable non-display region NDA can be reduced, a ratio of the effective area of the display region DA of the display apparatus DSP1 can be improved. Therefore, in the example shown in FIG. 2, the non-display region NDA can be reduced by a necessary space for the connection between the wiring board FWB1 and the substrate 10. The smaller the curvature radius of the bending region BND1 is, the smaller the area of the non-display region NDA is.

When the substrate 10 is bent so that the wiring board FWB1 or the circuit board CB1 is arranged to be closer to the back surface of the display region DA, it is necessary to electrically connect the transistor Tr1 (see FIG. 4) and various electrodes in the display region DA to various driving circuits (such as the signal-line driving circuit SD, the common-electrode driving circuit CD and others shown in FIG. 4) that are close to the back surface of the display region DA. Therefore, as exemplified in FIGS. 1 and 2, the plurality of wirings (first wiring) WR1 that are electrically connected to the transistor Tr1 (see FIG. 4) extend so as to straddle the peripheral region PF2, the bending region BND1 and the peripheral region PF1. In other words, the plurality of wirings (first wiring) WR1 are formed over the peripheral region PF2, the bending region BND1 and the peripheral region PF1. According to the studies of the present inventors, it has been found that the wiring WR1 arranged in the bending region BND1 is more susceptible to damage than the wiring not arranged in the bending region BND1, and therefore, the reliability of the display apparatus DSP1 is improved by protection of this wiring WR1.

As factors of the damage of the wiring WR1, for example, the following points are exemplified. First, in the bending region BND1, the substrate 10 and various members arranged on the substrate 10 are compressed or stretched in accordance with a distance from a center of the bending. More specifically, a portion of a bent member in the bending region BND1, the portion being closer to the center of the bending, is compressed. On the other hand, a portion of the bent member in the bending region BND1, the portion being farther from the center of the bending, is stretched. When the wiring WR1 is in the compressed portion or the stretched portion, stress (a vertical stress or a shear stress) is applied to the wiring WR1 in accordance with a force (bending moment) that is caused by the bending. When this stress is large, the wiring WR1 is damaged by the stress in some cases.

When the bending region BND1 is bent, in addition to the stress caused by the application of the bending moment onto the wiring WR1 itself, a stress caused on the peripheral members (such as the substrate 10 and the organic films OF1 and OF2) of the wiring WR1 propagates to the wiring WR1. Because of these stresses applied onto the wiring WR1, the wiring WR1 is damaged.

The inventors of the present application have studied a technique of suppressing the damage of the wiring WR1 in consideration of the above-described factors. As a result, it has been found that the damage of the wiring WR1 can be suppressed by suppression of concentrative stress application on a part of the wiring WR1. As shown in FIG. 6, the substrate 10 includes a portion (first portion) 10A overlapping the display region DA and the insulating film 11 that is the inorganic insulating film and a portion (second portion) 10B not overlapping the insulating film 11 and including the bending region BND1. The portion 10B is adjacent to the portion 10A including the display region DA. The wiring WR1 overlaps the portion 10A and the portion 10B. A thickness TH1B of the portion 10B (see FIG. 2) is smaller than a thickness TH1a of the portion 10A (see FIG. 2).

When the thickness of the substrate 10 in the bending region BND1 is reduced, the portion 10B of the substrate 10 is more susceptible to deformation than the portion 10A. When the portion 10A is susceptible to deformation, the stress caused when the portion 10A is bent and deformed is small. The present embodiment provides the smaller stress on the substrate 10 than that of a case with the portion 10A and the portion 10B having the same thickness as each other, and therefore, the stress propagating to the wiring WR1 becomes small. By the small stress propagating to the wiring WR1, the damage of the wiring WR1 due to the stress can be suppressed.

In order to suppress the damage of the wiring WR1, it is preferable to improve adhesiveness between the wiring WR1 and abase member of the wiring WR1. For example, when the wiring WR1 shown in FIG. 2 is directly formed on the front surface 10f of the substrate 10 and when the adhesiveness between the substrate 10 and the wiring WR1 is law, there is a concern of peeling of the wiring WR1 from the substrate 10, which results in phenomenon such as the damage of the wiring WR1 or short circuit between the adjacent wirings WR1 due to this peeling. When the wiring WR1 is formed on an inorganic insulating film while the inorganic insulating film is formed between the substrate 10 and the wiring WR1, adhesiveness between the wiring WR1 and the inorganic insulating film that is the base member is improved. However, such an inorganic insulating film as a silicon nitride film, a silicon oxide film or an aluminum oxide film is cracked by a bending moment, and is susceptible to be broken. Therefore, when the insulating film 11 is arranged in the bending region BND1, the insulating film 11 is cracked, this cracking of the insulating film 11 also propagates to the wiring WR1 layered on this insulating film, and the wiring WR1 is damaged.

In the case of the display apparatus DSP1 shown in FIG. 6, the organic film OF1 intervenes between the wiring WR1 and the substrate 10, and the wiring WR1 is formed on the organic film OF1. In other words, the organic film OF1 is adhered to each of the substrate 10 and the wiring WR1. Since the organic film OF1 is a film made of an organic material, the adhesiveness between the organic film OF1 and the substrate 10 is better than the adhesiveness between the wiring WR1 and the substrate 10 (in other words, an adhesion level is higher). And, since a different material from that of the substrate 10 can be used for the organic film OF1, the material can be selected in consideration of the adhesiveness with the wiring WR1.

For example, in the case of the display apparatus DSP1, the material of the organic film OF1 formed from the peripheral region PF2 to the bending region BND1 and the peripheral region PF1 is the same as the material of the insulating film 13 inside the display region DA. The material of the insulating film 13 is a material used for the base member forming the conductor pattern made of a metal or a conductive oxide. Therefore, the adhesiveness between the organic film OF1 and the wiring WR1 is better than the adhesiveness between the wiring WR1 and the substrate 10 (in other words, an adhesion level is higher). Besides, the organic film OF1 has a smaller Young modulus (in other words, softer) than those of the insulating films 11 and 12 that are the inorganic insulating films. Therefore, even when the organic film OF1 is arranged in the bending region BND1, the organic film OF1 is difficult to be broken. As a result, the wiring WR1 on the organic film OF1 is difficult to be damaged.

Meanwhile, in order to simply make the portion 10B easy to bend, it is only necessary to reduce the thickness of the portion 10B. Therefore, it is only necessary to thin either one or both of the front surface 10f and the back surface 10b of the substrate 10 shown in FIG. 2. In the present embodiment, the portion 10B of the substrate 10 is thin when being close to the front surface 10f of the substrate 10, and is not thin when being close to the back surface 10b of the same.

More specifically, as shown in FIG. 6, the front surface 10f of the substrate 10 has a step portion STP1 at a boundary between the portion 10A and the portion 10B. The configuration shown in FIG. 6 can be interpreted as follows. That is, the substrate 10 has a front surface 10f1 being in the portion 10A and facing the insulating film 11 that is the inorganic insulating film and a front surface 10f2 being in the portion 10B and facing the organic film OF1 in a thickness direction of the substrate 10.

After the substrate 10 is coated with a liquid coat solution, the organic film OF1 is formed by volatilization of a solvent component contained in the coat solution. A viscosity of the coat solution can be made low by adjustment of a viscosity of the solvent. Therefore, when surface evenness of abase layer of the coat solution is small, a front surface (upper surface) of the coat solution is flattened. However, when the base layer of the coat solution has a step having large difference in height (see, for example, the step portion STP1 shown in FIG. 6), the front surface of the coat solution is a tilt surface with respect to the X-Y plane (see FIG. 1). When the solvent contained in the coat solution is volatilized in this state, the front surface OFf1 of the organic film OF1 shown in FIG. 6 becomes a tilt surface with respect to the X-Y plane in a flat region (in the case of FIG. 6, the peripheral region PF2) other than the bending region BND1. In the example shown in FIG. 6, the front surface OFf1 of the organic film OF1 tilts with respect to the X-Y plane at a position overlapping the step portion STP1 and in periphery of the position.

In the display apparatus DSP1, as shown in FIG. 6, a thickness of the organic film OF1 is locally large in the periphery of the step portion STP1. Since the organic film OF1 is made of the material having the low Young modulus as described above, the thick portion of the organic film OF1 arranged on the step portion STP1 functions as a stress moderating portion that moderates the stress on the bending region BND1. By the stress moderating portion formed in vicinity of the bending region BND1, the stress generated on the wiring WR1 that is arranged in the bending region BND1 can be moderated.

In order to improve the stress moderating function of the organic film OF1 in the vicinity of the step portion STP1, the height difference of the step portion STP1 is preferably large. For example, in the example shown in FIG. 6, the height difference of the step portion STP1 is larger than the thickness of the insulating film 11. In other words, the height difference between the front surface 10f1 and the front surface 10f2 of the substrate 10 is larger than the thickness of the insulating film 11. The thickness of the insulating film 11 is, for example, several hundred nm (nanometer). On the other hand, the height difference of the step portion STP1 (in other words, the height difference between the front surface 10f1 and the front surface 10f2 of the substrate 10) is about 2 to 3 μm (micrometer).

In the display apparatus DSP1, the wiring WR1 is formed on the front surface OF1f of the organic film OF1. Therefore, the wiring WR1 is formed along a shape of the front surface OF1f of the organic film OF1. In the portion 10A of the substrate 10, the front surface 10f1 of the substrate 10 expands along the X-Y plane (see FIG. 1). The wiring WR1 tilts with respect to the X-Y plane at a position overlapping the step portion STP1 of the substrate 10. More specifically, the wiring WR1 tilts with respect to the X-Y plane at the position overlapping the step portion STP1 and in the peripheral region of the position. In this case, when the bending moment is applied to the portion of the wiring WR1, the portion being arranged in the bending region BND1, the tilt portion of the wiring WR1 functions as the moderating portion that moderates the stress on the bent portion of the wiring WR1.

The tilt portion of the wiring WR1 is closely adhered to the thick portion of the organic film OF1. Therefore, even when the tilt portion of the wiring WR1 is deformed by the moment applied on the bent portion of the wiring WR1, the stress can be suppressed from concentrating on the tilt portion of the wiring WR1.

As shown in FIG. 2, the substrate 10 has the back surface 10b opposite to the front surface 10f. In the region closer to the back surface 10b of the substrate 10, there is no step portion such as the step portion STP1 (see FIG. 6) at the boundary between the portion lap, and the portion 10B of the substrate 10. The portion 10B of the substrate 10 is susceptible to bending/deformation when being thinned as described above. However, in order to maintain the support strength of the substrate 10, the portion 10B of the substrate 10 is also preferable to have a certain thickness. In the case without the step portion in the region closer to the back surface 10b, the support strength of the portion 10B can be secured, and the height difference in the step portion STP1 as shown in FIG. 6 can be increased, as compared with the case with the step portion in the region closer to the back surface 10b.

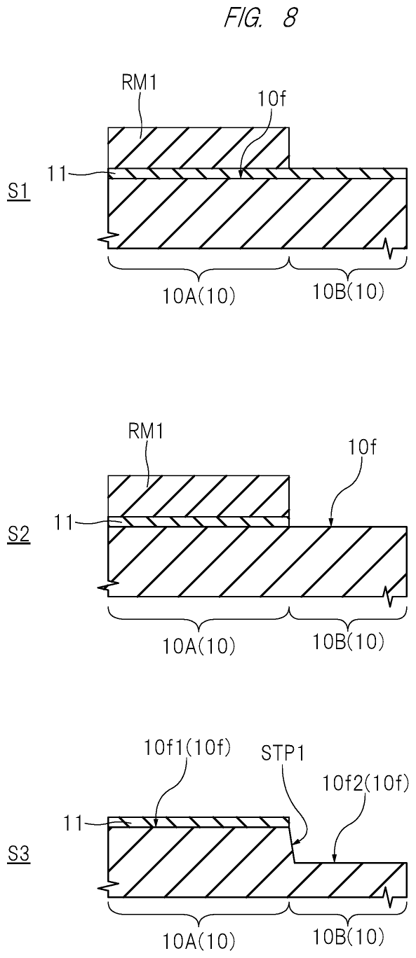

The step portion STP1 shown in FIG. 2 is formed at a position overlapping an end of the insulating film 11. The step portion STP1 can be formed by, for example, the following method. FIG. 8 is an enlarged cross-sectional view sequentially showing a step of forming the step portion shown in FIG. 6. The substate 10 including the insulating film 11 on the front surface 10f is prepared as shown in a step S1 in FIG. 8, and a mask RM1 is arranged so as to cover the surface of the portion 10A of the substrate 10. The insulating film 11 that is the inorganic film is formed by, for example, a sputter method or a CVD method. The insulating film 11 shown in FIG. 8 is also formed on the portion 10B of the substrate 10. The mask RM1 is a resist mask for use in etching.

Next, as shown in a step S2 in FIG. 8, a portion of the insulating film 11 covering the substrate 10, the portion overlapping the portion 10B, is selectively removed. As a method for the removal, for example, a dry etching method or others can be used. By this etching method, the portion 10B is exposed from the insulating film 11.

Next, as shown in a step S3 in FIG. 8, the mask RM1 is removed from the surface of the insulating film 11. The mask RM1 made of an organic film such as a resin can be removed by an ashing process. The substrate 10 is the organic film, and therefore, when the portion 10B of the substrate 10 is not particularly protected in the ashing process, a region of the portion 10B of the substrate 10, the region closer to the front surface 10f, is removed by the ashing process for removing the mask RM1. In this process, since the insulating film 11 functions as the resist mask for the aching process, a portion not overlapping the insulating film 11, that is the portion closer to the front surface 10f of the portion 10B, is selectively removed. In this manner, the step portion STP1 can be formed.

In this method, the step portion STP1 can be formed in the sequential steps of removing a part of the insulating film 11, and therefore, the step portion STP1 can be formed without increase in the manufacturing steps. And, by adjustment of conditions such as time for the ashing process, the height difference of the step portion STP1, in other words, the height difference between the front surface 10f1 and the front surface 10f2 can be controlled. When each step shown in FIG. 8 is performed before the bending of the portion 10B of the substrate 10, accuracy of the height difference of the step portion STP1 can be improved. In the case of the formation of the step portion STP1, by the above-described method, the step portion STP1 is formed at the position overlapping the insulating film 11 that is the inorganic insulating film.

As shown in FIG. 6, the wiring WR1 is arranged between the organic film (organic insulating film) OF1 and the organic film (organic insulating film) OF2. The organic film OF1 is in contact with the wiring WR1. The organic film OF2 is formed on surfaces of the plurality of wirings WR1, the surfaces being opposite to surfaces being in contact with the organic film OF1. The organic film OF2 covers the wiring WR1, and is closely adhered to the wiring WR1 and the organic film OF1 as shown in FIG. 7. Since the wiring WR1 is covered with the organic film OF2, the wiring WR1 can be protected from impact or water moisture contained in air.

When the wiring WR1 in the bending region BND1 is sandwiched between the organic film OF1 and the organic film OF2, the stress applied on the wiring WR1 can be reduced. When the substrate 10, the organic films OF1 and OF2 and the wiring WR1 are regarded as a unified layered film in the bending region BND1 shown in FIGS. 6 and 7, a neutral surface for the bending moment applied on the bending region BND1 in the thickness direction of the layered film is between the back surface 10b of the substate 10 (see FIG. 2) and the front surface OF2f of the organic film OF2. When the wiring WR1 is arranged in the neutral surface of the layered film, the stress applied on the wiring WR1 is ideally eliminated. Alternatively, when the wiring WR1 is arranged in vicinity of the neutral surface, the stress applied on the wiring WR1 can be reduced. A position of the neutral surface varies depending on a density of each material making the layered film, values of the Young modulus, a cross-sectional area and others.

In the present embodiment, as shown in FIG. 7, the organic film OF2 in the bending region BND1 is between the substrate 10 and the plurality of wiring WR1, and the plurality of wirings WR1 are between the organic film OF1 and the organic film OF2. Therefore, the densities of the organic film OF1 and the organic film OF2, the values of the Young modulus, the thickness (or the cross-sectional area) and others can be adjusted. Therefore, the stress applied on the wiring WR1 due to the bending can be smaller than that in the simple case in which the wiring WR1 is arranged on the front surface 10f of the substrate 10.

In order to suppress the damage of the wiring WR1, it is preferable to improve the adhesiveness between the wiring WR1 and the base member of the wiring WR1. For example, in a case of a display apparatus DSP2 shown in FIG. 8, the wiring WR1 is directly arranged on the front surface 10f of the substrate 10. If the adhesiveness between the wiring WR1 and the substrate 10 is low, there is a concern that the wiring WR1 and the substrate 10 are peeled off from each other, which results in phenomenon such as the damage of the wiring WR1 and the short circuit between the adjacent wirings WR1 due to this peeing off. As a countermeasure against the phenomenon, the inventors of the present application have studied an aspect of the formation of the wiring WR1 on the insulating film 11 so as to extend the insulating film 11 that is the inorganic insulating film over the peripheral region PF2 and the bending region BND1. When the inorganic insulating film is formed between the substrate 10 and the wiring WR1 while the wiring WR1 is formed on the inorganic insulating film, the adhesiveness between the wiring WR1 and the inorganic insulating film that is the base member is improved. However, the inorganic insulating film such as a silicon nitride film, a silicon oxide film or an aluminum oxide film is susceptible to be broken because of being cracked by the bending moment. Therefore, when the insulating film 11 is arranged in the bending region BND1, the insulating film 11 is cracked, the cracking of the insulating film 11 propagates to the wiring WR1 layered on this insulating film, and the wiring WR1 is damaged.

In the case of the display apparatus DSP1 shown in FIG. 6, the organic film OF1 intervenes between the wiring WR1 and the substrate 10, and the wiring WR1 is formed on the organic film OF1. In other words, the organic film OF1 is adhered on each of the substrate 10 and the wiring WR1. Since the organic film OF1 is the film made of the organic material, the adhesiveness between the organic film OF1 and the substrate 10 is better (in other words, higher in the adhesive strength) than the adhesiveness between the wiring WR1 and the substrate 10. And, for the organic film OF1, a different material from that of the substrate 10 can be used, and therefore, the material can be selected in consideration of the adhesiveness with the wiring WR1.

For example, in the case of the display apparatus DSP1, the organic film OF1 that is formed from the peripheral region PF2 to the bending region BND1 and the peripheral region PF1 is made of the same material as that of the insulating film 13 inside the display region DA. The insulating film 13 is the member used for the base member forming the conductor pattern made of a metal or a conductive oxide. Therefore, the adhesiveness between the organic film OF1 and the wiring WR1 is better (in other words, higher in the adhesive strength) than the adhesiveness between the wiring WR1 and the substrate 10. Further, the organic film OF1 has a smaller Young modulus (in other words, is softer) than the insulating film 12 and the insulating film 11 that are the inorganic insulating films. Therefore, even when the organic film OF1 is arranged in the bending region BND1, the organic film OF1 is not susceptible to be broken. As a result, the wiring WR1 that is formed on the organic film OF1 is not susceptible to be damaged.

As shown in FIG. 5, each of the display region DA and the peripheral region PF2 includes a plurality of wirings WR2 that electrically connect the plurality of transistors Tr1 and the wiring WR1. In the present embodiment, the wiring WR2 is a source line SL formed in the conductive layer CL2. In the peripheral region PF2, a plurality of openings CH1 are formed in the organic film OF1 or the insulating film 13. The plurality of wirings WR1 are connected to the plurality of wirings WR2 through the plurality of openings CH1, respectively. The plurality of wirings WR1 are connected to the plurality of wirings WR2 inside the plurality of openings CH1, respectively. The plurality of openings CH1 shown in FIG. 5 are contact holes that electrically connect the wirings WR1 and the wirings WR2, respectively. As shown in FIG. 6, at the base surface of the opening CH1, a part of the wiring WR2 is exposed from the organic film OF1. The wiring WR1 is adhered to the exposed portion of the wiring WR2.

As shown in FIG. 6, on the front surface 10f of the substrate 10, there is the inorganic insulating film (the insulating films 11 and 12 shown in FIG. 6) extending so as to straddle the display region DA and the peripheral region PF2. The plurality of openings CH1 of the organic film OF1 are at positions overlapping this inorganic insulating film in a planar view. The plurality of wirings WR2 are on this inorganic insulating film, and terminate on this inorganic insulating film. In other words, the insulating films 11 and 12 that are the inorganic insulating films terminate at the peripheral region PF2, and do not straddle the boundary between the bending region BND1 and the peripheral region PF1. And, each of the plurality of wiring WR2 terminates at a position closer to the display region DA than the terminate portion of the insulating film 11 in a planar view.

In the case of the display apparatus DSP1, the sealing member SLM shown in FIG. 6 and the organic film OF2 are made of the different materials from each other. When the organic film OF2 is made of the different material from that of the sealing member SLM, a degree of freedom of the option of the material making the organic film OF2 increases. Therefore, it is easy to adjust the position of the formation of the wiring WR1 so as to be closer to the neutral surface for the bending of the bending region BND1. When a material having high adhesiveness with the organic film OF1 shown in FIG. 7 is selected as the material making the organic film OF2, the adhesive strength of the organic film OF1 with the organic film OF2 is improved between the adjacent wirings WR1. For example, when the material making the front surface OF1f of the organic film OF1 and the material making the back surface OF2b of the organic film OF2 are the same organic material as each other, the adhesiveness between the organic film OF1 and the organic film OF2 is high.

As shown in FIG. 2, one end of the wiring WR1 is connected to the wiring WR2 in the peripheral region PF2, and the other end thereof is connected to the wiring board FWB1 in the peripheral region PF1. More specifically, the wiring WR1 is connected to a terminal TM1 in the peripheral region PF1. The terminal TM1 is arranged so as to face a terminal TM2 of the wiring board FWB1. The terminal TM1 and the terminal TM2 are electrically connected to each other through an anisotropic conductive film ACF1. The anisotropic conductive film ACF1 contains a plurality of conductive particles and an insulating film around the plurality of conductive particles. In other words, the anisotropic conductive film ACF1 is the insulating film containing the plurality of conductive particles. As similar to the wiring WR1, the terminal TM1 is formed on the front surface OF1f of the organic film OF1 (see FIG. 6). The terminal TM1 is exposed from the organic film OF2. However, the organic film OF2 extends to a vicinity of a region where the terminal TM1 is arranged. Most part of the wiring WR1 is covered with the organic film OF2.

### First Modification Example

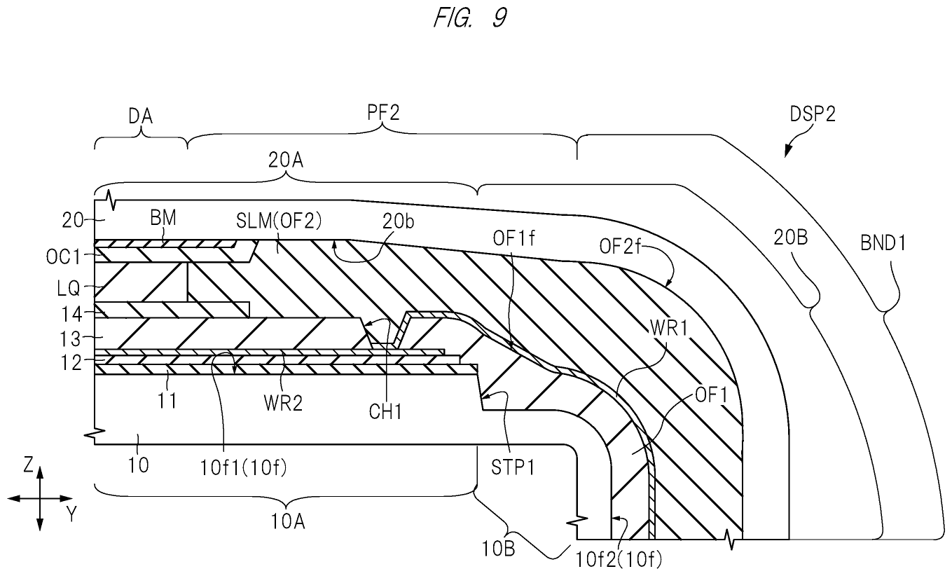

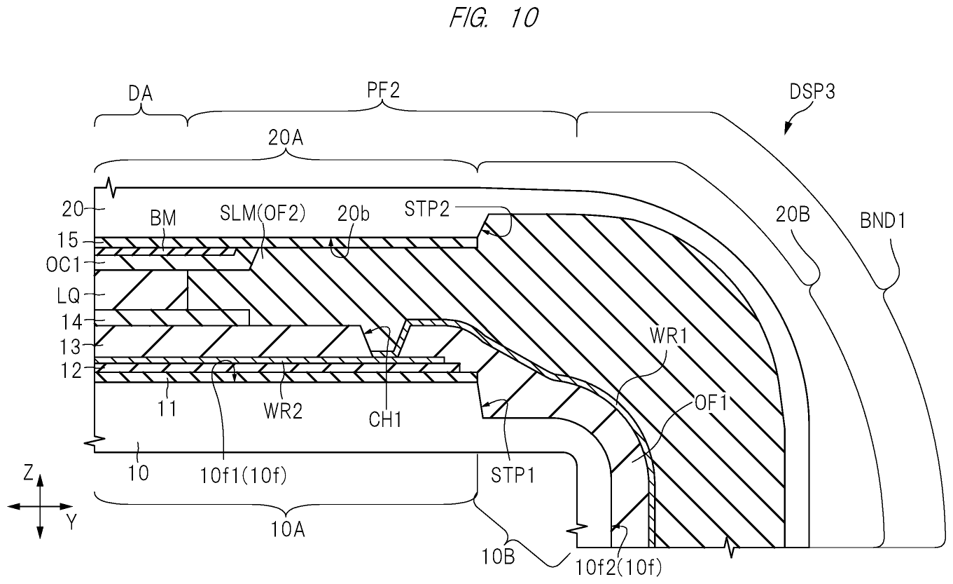

Next, various modification examples of the display apparatus DSP1 will be sequentially explained. FIG. 9 is an enlarged cross-sectional view of a display apparatus according to a modification example of the display apparatus shown in FIG. 6. FIG. 10 is an enlarged cross-sectional view of a display apparatus according to a modification example of the display apparatus shown in FIG. 9.

The display apparatus DSP2 shown in FIG. 9 is different from the display apparatus DSP1 shown in FIG. 6 in that the substrate 20 is bent as similar to the substrate 10. More specifically, the substrate 20 of the display apparatus DSP2 has flexibility, and extends so as to straddle the display region DA, the peripheral region PF2, the bending region BND1 and the peripheral region PF1. The organic film OF2 is covered with the substrate 20. The substrate 20 is bent along the bending shape of the organic film OF2. The front surface OF2f of the organic film OF2 and the back surface 20b of the substrate 20 are in contact with (closely adhered to) each other. In other words, the layered film including the organic film OF1, the wiring WR1 and the organic film OF2 is sandwiched between the substrate 10 and the substrate 20.

The substrate 20 included in the display apparatus DSP2 has flexibility. The substrate 20 has a portion 20A facing the portion 10A of the substrate 10 and a portion 20B facing the portion 10B of the substrate 10. The portion 20A faces the portion 10A of the substrate 10 through the liquid crystal layer LQ. The portion 20B of the substrate 20 faces the portion 10B of the substrate 10 through the sealing member SLM. In this manner, even when the wiring WR1 is arranged between the substrate 10 and the substrate 20, if the substrate 10 has the step portion STP1, the stress applied on the wiring WR1 can be reduced.

In the case of the display apparatus DSP2, since the organic film OF1 and the organic film OF2 (the sealing member SLM) are sandwiched between the substrate 10 and the substrate 20, the water moisture is difficult to enter the organic film OF1 and the organic film OF2. Therefore, the wiring WR1 that is positioned between the organic film OF1 and the organic film OF2 can be suppressed from corrosion due to influence of the water moisture.

As shown in FIG. 9, the organic film OF2 is made of the same material as that of the sealing member SLM, and is unified with the sealing member SLM. In order to bend the substrate 20 to be along the shape of the organic film OF2, it is preferable to adhesive the front surface OF2f of the organic film OF2 and the back surface 20b of the substrate 20. When the front surface OF2f of the organic film OF2 is the sealing member SLM as described in the display apparatus DSP2, the adhesive strength with the substrate 20 can be improved. And, when the entire part of the organic film OF2 is the sealing member SLM as described in the display apparatus DSP2, the step of separately forming the organic film OF2 shown in FIG. 6 is unnecessary. Therefore, the manufacturing efficiency of the display apparatus DSP2 can be improved.

The display apparatus DSP2 shown in FIG. 9 is the same as the display apparatus DSP1 shown in FIG. 6 except in the following different points, and therefore, explanation for overlapping will be omitted.

### Second Modification Example

FIG. 10 is an enlarged cross-sectional view of a display apparatus according to a modification example of FIG. 9. A display apparatus DSP3 shown in FIG. 10 is different from the display apparatus DSP2 shown in FIG. 9 in that an insulating film 15 that is an inorganic insulating film is formed on the back surface 20b of the substrate 20 included in the display apparatus DSP3. The insulating film 15 that is the inorganic insulating film is formed on the portion 20A of the substrate 20. The insulating film 15 is the same inorganic insulating film as or a different inorganic insulating film from the insulating films 11 and 12, and the insulating film 15 is, for example, a silicon nitride (SiN) film, a silicon oxide (SiO) film, an aluminum oxide (AlOx) film or a layered film of these films.

The entering of the water moisture is more prevented by the insulating film 15 that is the inorganic insulating film than the substrates 10 and 20. Therefore, when the back surface 20b of the substrate 20 is covered with the insulating film 15 that is the inorganic insulating film, the water moisture is prevented from entering the liquid crystal layer LQ. However, as similar to the insulating film 11 explained above, the insulating film 15 that is the inorganic insulating film is susceptible to be broken by the influence of the bending moment. Therefore, in order to prevent the breaking of the insulating film 15, it is preferable not to form the insulating film 15 in the portion 20B (more specifically, the portion 20B including the bending region BND1) of the substrate 20 as seen in the display apparatus DSP3.

However, in the case of the display apparatus DSP3, when a distance between the substrate 20 and the wiring WR1 is sufficiently large, even the cracking on the insulating film 15 does not reach the wiring WR1 in some cases. For example, when the wiring WR1 is not formed in the region closer to the substrate 20, the insulating film 15 is formed at a position overlapping the portion 20B in some cases.

In a region closer to the back surface 20b, the substrate 20 of the display apparatus DSP3 has a step portion STP2 between the portion 20A overlapping the insulating film 15 and the portion 20B not overlapping the insulating film 15. In this case, the portion 20B of the substrate 20 is thinner than the portion 20A. When the portion 20B in the bending region BND1 is thinned as described above, the substrate 20 is susceptible to be bent. In the case with the step portion STP2, the organic film OF2 (the sealing member SLM in the examples of FIG. 10) between the portion 20B of the substrate 20 and the portion 10 of the substrate 10 is thick. In the example of FIG. 10, the arrangement of the sealing member SLM of one type between the wiring WR1 and the substrate 20 has been exemplified. However, a plurality of organic films can be layered between the wiring WR1 and the substrate 20.

In this case, it is easy to adjust the position of the neutral surface of the bending region BND1 by adjustment of the density of each material making the layered film between the wiring WR1 and the substrate 20, the values of the Young modulus and the cross-sectional area and others.

### Third Modification Example

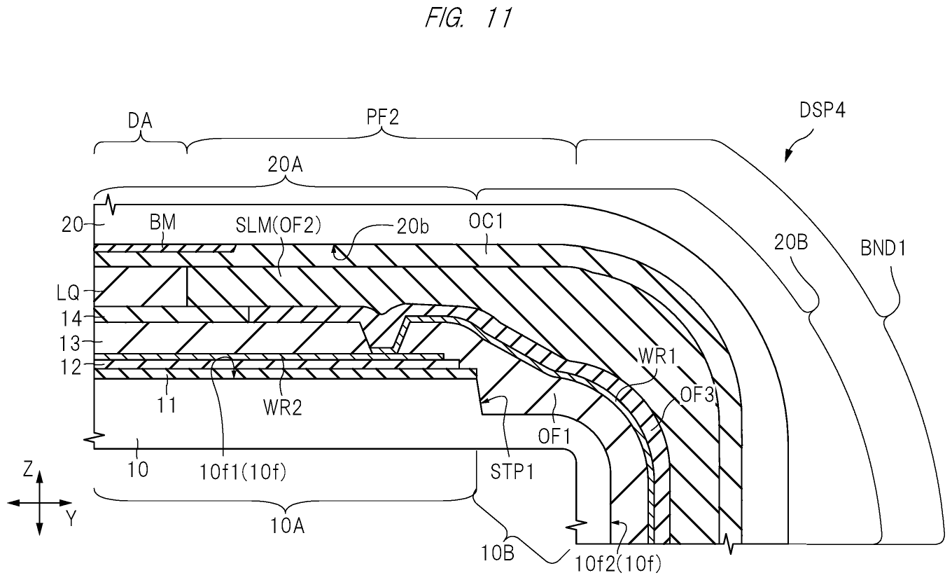

FIG. 11 is an enlarged cross-sectional view of a display apparatus according to another modification example of FIG. 9. A display apparatus DSP4 shown in FIG. 11 is different from the display apparatus DSP2 shown in FIG. 9 in that an organic film OF3 is formed between the sealing member SLM and the wiring WR1 and in that an insulating film OC1 is arranged between the substrate 20 and the sealing member SLM.

More specifically, the display apparatus DSP4 includes the organic film OF3 between the sealing member SLM and the organic film OF1 in a region overlapping the portion 10B of the substrate 10 and the portion 20B of the substrate 20. The organic film OF3 faces the organic film OF1. A thickness of the organic film OF3 is about the same as the thickness of the insulating film 14 but is smaller than the thickness of the organic film OF1.

When the substrate 10 has the step portion STP1, a separate distance between the portion 10B of the substrate 10 and the portion 20B of the substrate 20 is larger than a separate distance between the portion 10A and the portion 20A. In the case of the liquid crystal display apparatus, in order to improve the display quality, a thickness of the liquid crystal layer LQ is preferably nearly constant. Since the bending region BND1 itself is the non-display region NDA as shown in FIG. 1, the large separate distance between the substrate 10 and the substrate 20 in the bending region BND1 is no problem.

However, when the separate distance between the substrate 10 and the substrate 20 is instable in the vicinity of the liquid crystal layer LQ, a thickness of an end of the liquid crystal layer LQ is instable in some cases. For example, when the separate distance between the substrate 10 and the substrate 20 in the vicinity of the liquid crystal layer LQ is small because of the influence of the bending of the bending region BND1 of the substrate 10 and the substrate 20, the thickness of the end of the liquid crystal layer LQ is small. Alternatively, when the separate distance between the substrate 10 and the substrate 20 is large, the thickness of the end of the liquid crystal layer LQ is large.

The display apparatus DSP4 includes the organic film OF3 covering the organic film OF1 and the wiring WR1, and the thickness of the organic film OF3 is nearly as the same as the thickness of the insulating film 14. The region closer to the surface 20b of the substrate 20 is covered with the organic film OC1. In this case, in the vicinity of the liquid crystal layer LQ (such as a region overlapping the step portion STP1), a separate distance between the organic film OF3 and the insulating film OC1 is nearly as the same as the thickness of the liquid crystal layer LQ. Therefore, the instability of the thickness of the end of the liquid crystal layer LQ can be suppressed. In the example shown in FIG. 11, in the portion 20B, the insulating film covering the back surface 20b of the substrate 20 is the insulating film OC1 extending from the display region DA to the bending region BND1. However, as a modification example, the back surface 20b of the substrate 20 may be covered with an organic film that is separately formed from the insulating film OC1 shown in FIG. 11. In this case, a thickness of the organic film covering the back surface 20b is preferably nearly the same as the thickness of the insulating film OC1.

### Fourth Modification Example

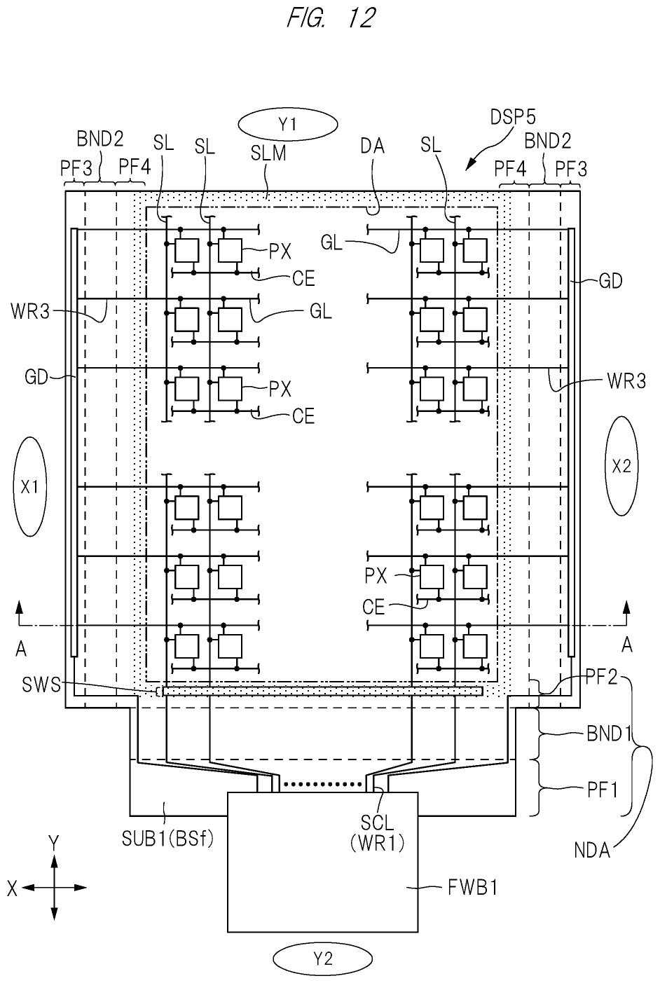

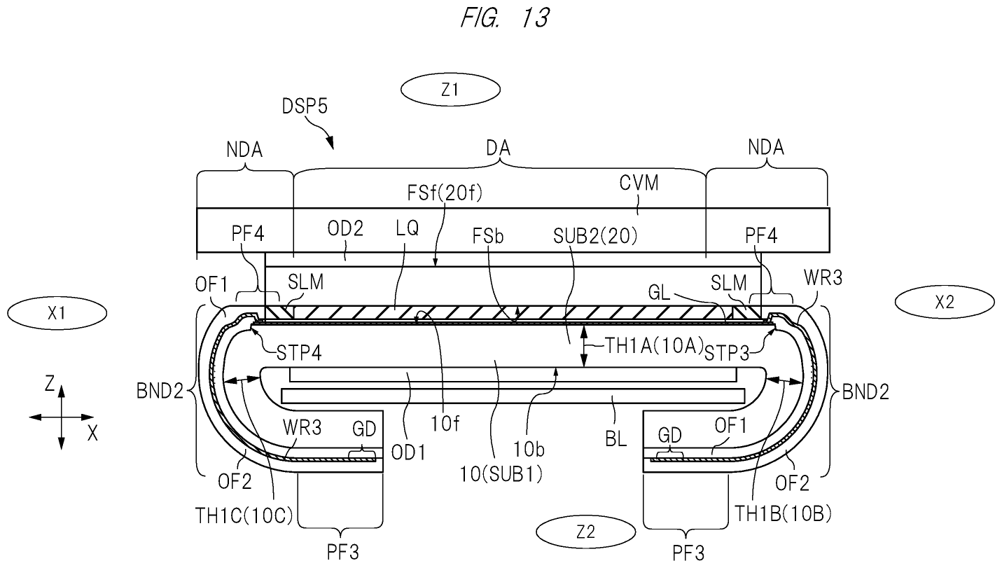

FIG. 12 is a planar view showing a modification example of FIG. 1. FIG. 13 is a cross-sectional view taken along a line A-A of FIG. 12. A display apparatus DSP5 shown in FIGS. 12 and 13 is different from the display apparatus DSP1 shown in FIG. 1 in that each of regions close to the X1 and the X2 in the X direction crossing (more specifically, being orthogonal to) the Y direction has a bending region BND2.

Each of the display apparatus DSP1 (see FIG. 1) and the display apparatus DSP5 includes: the peripheral regions PF1 and PF2 and the bending region BND1 out of the display region DA in the Y direction. The display apparatus DSP5 includes peripheral regions PF3 and PF4 and the bending region BND2 out of the display region DA in the X direction in addition to the peripheral regions PF1 and PF2 and the bending region BND1. The display apparatus DSP5 includes: the display region DA surrounded by the sealing member SLM; the peripheral region PF3 out of (in other words, on a circumference of) the display region DA; the peripheral region PF4 that is adjacent to the display region DA and that is between the peripheral region PF3 and the display region DA; and the bending region BND2 between the peripheral region PF4 and the peripheral region PF3. The bending region BND2 is a portion at which the substrate 10 shown in FIG. 13 and each member arranged on the substrate 10 are bent, and has a certain area. In FIG. 12, each of a boundary between the peripheral region PF1 and the bending region BND1, a boundary between the peripheral region PF2 and the bending region BND1, a boundary between the peripheral region PF3 and the bending region BND2 and a boundary between the peripheral region PF4 and the bending region BND2 is shown with a dotted line.

The display apparatus DSP5 includes a plurality of wirings WR3 that are electrically connected to the transistor Tr1 (see FIG. 4) of the display region DA through the gate line GL. The plurality of wirings (third wirings) WR3 extend over the peripheral region PF4, the bending region BND2 and the peripheral region PF3. Since the wiring WR3 is arranged in the bending region BND2, it is preferable to make a countermeasure for suppressing the damage due to the bending moment as similar to the wiring W1 shown in FIGS. 5 and 6. Although repeated explanation is omitted, the damage of the wiring WR3 can be suppressed by the countermeasure for the wiring WR1 explained with reference to FIGS. 1 to 13 onto the wiring WR3.

For example, as shown in FIG. 13, the substrate 10 of the display apparatus DSP5 includes: a portion 10A including the display region DA and overlapping the insulating film 11 (see FIG. 6) that is the inorganic insulating film; a portion 10B not overlapping the insulating film 11 and including the bending region BND2; and a portion 10C not overlapping the insulating film 11 and including the bending region BND2, the portion 10C being opposite to the portion 10B in a planar view. The wiring WR3 overlaps the portion 10A and the portion 10B. Each of a thickness TH1B of the portion 10B and a thickness THTC of the portion 10C is smaller than a thickness TH1A of the portion 10A. The front surface 10f of the substrate 10 has a step portion STP3 at the boundary between the portion 10A and the portion 10B. And, the front surface 10f of the substrate 10 has a step portion STP4 at the boundary between the portion 10A and the portion 10C.

### Fifth Modification Example

The techniques explained with reference to FIGS. 1 to 13 are also applicable to a display apparatus including a touch sensor that detects an input command from outside as a signal. The display apparatus with the touch sensor includes a wiring connected to the touch sensor, in addition to a wiring connected to a display circuit. Therefore, the arrangement density of the wirings is higher than, for example, that of the display apparatus DSP1 shown in FIG. 1.

It would be understood that various modification examples and alteration examples could have been anticipated within the concept of the present invention by those who are skilled in the art, and understood that these modification examples and alteration examples are also within the scope of the present invention. For example, the ones obtained by appropriate addition, removal, or design-change of the components to/from/into each of the above-described embodiments by those who are skilled in the art or obtained by addition, omitting, or condition-change of the step to/from/into each of the above-described embodiments are also within the scope of the present invention as long as they include the outline of the present invention.

### INDUSTRIAL APPLICABILITY

The present invention can be utilized for a display apparatus and an electronic device in which the display apparatus is embedded.

1. An electrooptic apparatus comprising:
a flexible first substrate having a first front surface;
an electrooptic layer formed above the first front surface of the first substrate;
a transistor element between the first substrate and the electrooptic layer;
a first wiring being closer to the first front surface and electrically connected to the transistor element;
a first organic film formed between the electrooptic layer and the first wiring;
a second organic film formed above the first organic film and facing the first organic film; and
a first inorganic insulating film formed between the first wiring and the first substrate and formed on the first front surface of the first substrate,
wherein the first substrate further includes:
a first portion that overlaps a display region and the first inorganic insulating film; and
a second portion that is adjacent to the display region, does not overlap the first inorganic insulating film and includes a bending region,
the first wiring is sandwiched between the first organic film and the second organic film, and
a thickness of the second portion of the first substrate is smaller than a thickness of the first portion.

2. The electrooptic apparatus according to claim 1,
wherein, in a region closer to the first front surface, the first substrate has a first step portion at a boundary between the first portion and the second portion.

3. The electrooptic apparatus according to claim 2,
wherein a height difference of the first step portion is larger than a thickness of the first inorganic insulating film.

4. The electrooptic apparatus according to claim 2,
wherein, in the first portion, the first front surface of the first substrate expands along a first plane, and
the first wiring tilts with respect to the first plane at a position overlapping the first step portion of the first substrate.

5. The electrooptic apparatus according to claim 2,
wherein the first substrate has a first back surface opposite to the first front surface, and,
in a region closer to the first back surface, the first substrate has no step portion at the boundary between the first portion and the second portion.

6. The electrooptic apparatus according to claim 1,
wherein the first substrate includes:
the first front surface being in the first portion and facing the first inorganic insulating film; and
a second front surface being in the second portion, being at a height different from the first front surface in a thickness direction of the first substrate, and facing the first organic film, and
a height difference between the first front surface and the second front surface is larger than a thickness of the first inorganic insulating film.

7. The electrooptic apparatus according to claim 1 further comprising:
a second substrate having a second back surface facing the first front surface of the first substrate and being adhered to the first substrate through a sealing member,
wherein the second substrate has flexibility and includes:
a third portion facing the first portion of the first substrate; and
a fourth portion facing the second portion of the first substrate through the sealing member, and
the electrooptic layer is made of a liquid crystal layer.

8. The electrooptic apparatus according to claim 7,
wherein a second inorganic insulating film is arranged on the third portion of the second substrate,
the fourth portion of the second substrate does not overlap the second inorganic insulating film, and,
in a region closer to the second back surface, the second substrate has a second step portion at a boundary between the third portion and the fourth portion.

9. The electrooptic apparatus according to claim 1,
wherein, in a region overlapping the second portion of the first substrate and the fourth portion of the second substrate, a third organic film facing the first organic film is arranged between the first organic film and the sealing member.

10. The electrooptic apparatus according to claim 3,
wherein, in the first portion, the first front surface of the first substrate expands along a first plane, and
the first wiring tilts with respect to the first plane at a position overlapping the first step portion of the first substrate.

11. The electrooptic apparatus according to claim 3,
wherein the first substrate has a first back surface opposite to the first front surface, and,
in a region closer to the first back surface, the first substrate has no step portion at the boundary between the first portion and the second portion.

12. The electrooptic apparatus according to claim 4,
wherein the first substrate has a first back surface opposite to the first front surface, and,
in a region closer to the first back surface, the first substrate has no step portion at the boundary between the first portion and the second portion.

13. The electrooptic apparatus according to claim 10,
wherein the first substrate has a first back surface opposite to the first front surface, and,
in a region closer to the first back surface, the first substrate has no step portion at the boundary between the first portion and the second portion.

14. The electrooptic apparatus according to claim 2 further comprising:
a second substrate having a second back surface facing the first front surface of the first substrate and being adhered to the first substrate through a sealing member,
wherein the second substrate has flexibility and includes:
a third portion facing the first portion of the first substrate; and
a fourth portion facing the second portion of the first substrate through the sealing member, and
the electrooptic layer is made of a liquid crystal layer.

15. The electrooptic apparatus according to claim 3 further comprising:
a second substrate having a second back surface facing the first front surface of the first substrate and being adhered to the first substrate through a sealing member,
wherein the second substrate has flexibility and includes:
a third portion facing the first portion of the first substrate; and
a fourth portion facing the second portion of the first substrate through the sealing member, and
the electrooptic layer is made of a liquid crystal layer.

16. The electrooptic apparatus according to claim 4 further comprising:
a second substrate having a second back surface facing the first front surface of the first substrate and being adhered to the first substrate through a sealing member,
wherein the second substrate has flexibility and includes:
a third portion facing the first portion of the first substrate; and
a fourth portion facing the second portion of the first substrate through the sealing member, and
the electrooptic layer is made of a liquid crystal layer.
